(19) United States
(12) Patent Application Publication
(10) Pub. No.: US 2013/0239542 A1
(43) Pub. Date: Sep. 19, 2013

(54) STRUCTURES AND METHODS FOR INTERCOOLING AIRCRAFT GAS TURBINE ENGINES

(71) Applicants: Arindam Dasgupta, West Hartford, CT (US); Om P. Sharma, South Windsor, CT (US)

(72) Inventors: Arindam Dasgupta, West Hartford, CT (US); Om P. Sharma, South Windsor, CT (US)

(73) Assignee: UNITED TECHNOLOGIES CORPORATION, Hartford, CT (US)

(21) Appl. No.: 13/421,906

(22) Filed: Mar. 16, 2012

(51) Int. Cl. F02C 7/143; F02C 7/00

(52) U.S. Cl. 60/39.093; 415/116; 60/806

(57) ABSTRACT

A turbine engine has a fan comprising a duct and supporting struts, a first compressor configured to pressurize inlet air, and a second compressor configured to further pressurize the inlet air. A cooling circuit is located to cool the inlet air after the inlet air is pressurized by the first compressor and before the inlet air is further pressurized by the second compressor, and includes at least intercooler configured to transfer heat from inlet air to a secondary fluid heat sink.

### BACKGROUND

The subject matter disclosed herein relates generally to a gas turbine engine, and in particular, to a gas turbine engine including an intercooler.

Gas turbine engines typically include a compressor section that draws air into the engine and compresses the air; a combustor section that mixes the compressed air with fuel and ignites the mixture; and a turbine section that converts energy of the combustion process to rotational energy.

To improve efficiency of the turbine engine, intercooling may be employed. Intercooling includes removing energy from the air between compression stages. The energy is conventionally removed by way of a heat exchanger. That is, air that has been compressed during a first stage is directed through the heat exchanger before being compressed further during subsequent stages. A coolant is directed in counter- or cross-flow direction through the heat exchanger to remove energy from the partially compressed air. By removing energy, the work of compression lessens, and more turbine power is available than would have been otherwise possible without intercooling.

Intercooling is currently used in some land-based gas turbine and reciprocating engines, but has not been used in aerospace applications. Although coolers, refrigeration systems, and other devices are effective in facilitating high power output from gas turbine engines, the known systems and devices typically require components which increase engine weight and cost of operation, including additional maintenance considerations.

### SUMMARY

In one embodiment, a turbine engine has a fan comprising a duct and supporting struts, a first compressor configured to pressurize inlet air, and a second compressor configured to further pressurize the inlet air. A cooling circuit is located to cool the inlet air after the inlet air is pressurized by the first compressor and before the inlet air is further pressurized by the second compressor, and includes at least one intercooler configured to transfer heat from inlet air to a secondary fluid source or heat sink.

In another embodiment, a gas turbine engine has a fan with a duct and supporting struts, a low pressure turbine, a low pressure compressor coupled to the low pressure turbine by a first shaft, a high pressure compressor, a high pressure turbine coupled to the high pressure compressor by a second shaft, a combustor located at an outlet of the high pressure compressor; and an intercooler coupled to an outlet of the low pressure compressor and to an inlet of the high pressure compressor.

In one embodiment, a method of generating power includes pressurizing air during a first compression stage, and further pressurizing the air during a second compression stage. Heat is transferred from the pressurized air between the first compression stage and second compression stage by passing the pressurized air adjacent a secondary fluid, which reduces the temperature of the air. A mixture of the further pressurized air and fuel is combusted.

### BRIEF DESCRIPTION OF THE DRAWINGS

FIG. 1 is a schematic view of a gas turbine engine employing an intercooling circuit with an indirect heat sink.

FIG. 2 is a schematic view of a gas turbine engine with direct intercooling.

FIG. 3 is a schematic view of a gas turbine engine with an intercooling circuit with auxiliary power generation.

FIG. 4 is a schematic view of a gas turbine engine employing an intercooling circuit utilizing fuel as a cooling fluid.

FIG. 5 is a schematic view of a gas turbine engine with an intercooling circuit having a surface heat exchanger in a fact duct.

FIG. 6 is a schematic view of a gas turbine engine with an intercooling circuit with heat exchangers in fan struts.

FIG. 7 is a schematic view of a gas turbine engine with an intercooling circuit utilizing a heat exchanger placed in an aircraft wing.

### DETAILED DESCRIPTION

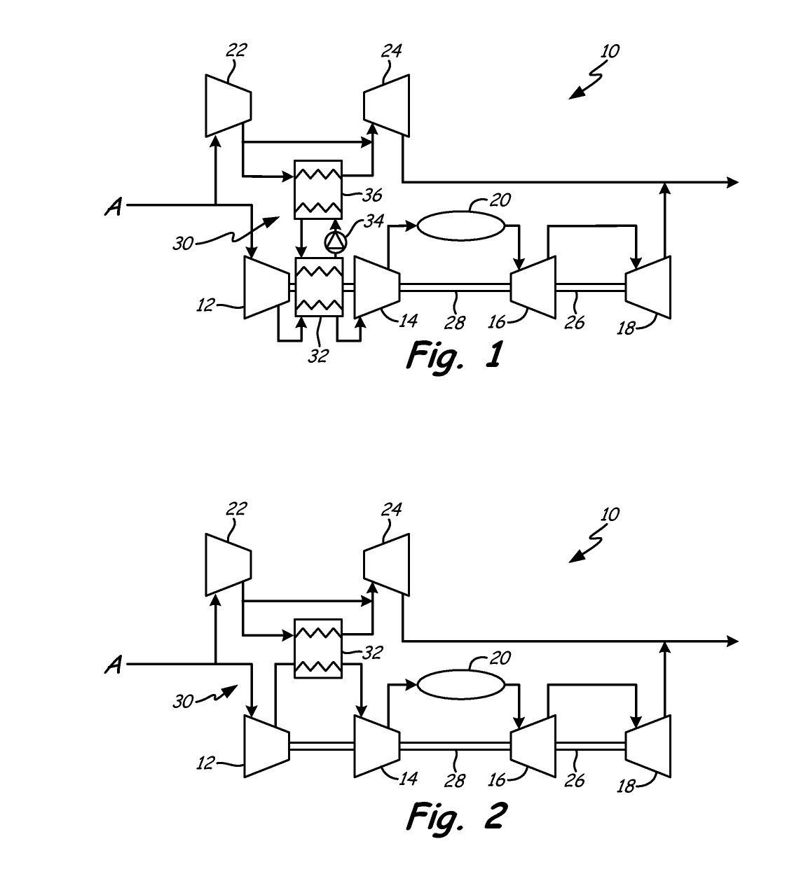

FIG. 1 illustrates an exemplary turbine engine 10. Turbine engine 10 may be associated with aerospace applications, such as a turbofan engine for an aircraft. Turbine engine 10 may include first compressor section 12, second compressor section 14, first turbine section 16, second turbine section 18, combustor section 20, fan section 22, and nozzle section 24. First shaft 26 connects first compressor section 12 to second compressor section 18, and second shaft 28 connects second compressor section 14 to first turbine section 16. Turbine engine 10 may also include cooling circuit 30 having intercooler 32 and fluid system 34. Airflow A through the engine is noted by arrows.

Compressor sections 12 and 14 may include components rotatable to compress inlet air. Specifically, compressor sections 12 and 14 may each include one or more stages having a series of rotatable compressor blades (not shown) fixedly connected about central shafts 26 and 28. As central shafts 26 and 28 are rotated, air may be drawn into turbine engine 10 and pressurized. As illustrated in FIG. 1, turbine engine 10 may be a multi-stage turbine engine. That is, turbine engine 10 may include at least two compressor sections 12 and 14, for example, a low pressure section and a high pressure section respectively, fluidly interconnected by way of a passage. First compressor section 12 may receive inlet air and pressurize the inlet air to a first pressure level. Second compressor section 14 may receive the partially compressed air from first compressor section 12 and further pressurize the air to a second pressure level. The pressurized air will increase in temperature through each successive compression stage.

The highly pressurized air may then be directed toward combustor section 20 for mixture with a liquid and/or gaseous fuel. Combustor section 20 may mix fuel, and combust the mixture to create a high temperature gaseous mixture. Specifically, combustor section 20 may include a combustion chamber and one or more fuel nozzles (not shown). Each fuel nozzle may inject or otherwise deliver one or both of liquid and gaseous fuel into the flow of compressed air from second compressor section 14 for ignition within combustion chamber. As the fuel/air mixture combusts, heated exhaust may expand and move at high speed into first turbine section 16 by way of a passage.

Turbine sections 16 and 18 may include components rotatable in response to the flow of expanding exhaust gases from combustor section 20, as well as stationary components to direct the flow of exhaust gases. In particular, turbine sections 16 and 18 may include a series of rotatable turbine blades (not shown) fixedly connected about central shafts 26 and 28. Similar to compressor sections 12 and 14, turbine sections 16 and 18 may also include low pressure section 16 and a high pressure section 18 fluidly connected by way of a passage. As the exhaust from combustor section 20 flows over the turbine blades, the exhaust may cause central shaft 20 to rotate, thereby converting combustion energy into useful rotational power. The rotation of the turbine rotor blades and shafts 26 and 28 may drive the rotation of the compressor blades within compressor sections 12 and 14.

Turbine engine 10 may also include cooling circuit 30 that functions to further increase the efficiency of turbine engine 10. Cooling circuit 30 may include components that transfer heat away from air that has been partially compressed by first compressor section 12 before it is further compressed by second compressor section 14. Cooling circuit 30 may be an indirect system that includes intercooler 32, heat sink 36, and fluid system 34. Intercooler 32 is connected to a heat sink 36 configured to transfer heat from the partially compressed inlet air to a secondary cooling fluid. Fluid system 34 may include one or more pumps and valves that promote the flow of the compressed air and/or secondary cooling fluid between intercooler 32 and heat sink 36, which may both be heat exchangers.

FIG. 1 is a view of turbine engine 10 employing cooling circuit 30 with an indirect heat sink 36. As illustrated in FIG. 1, air enters turbine engine 10, and a portion may be provided to each of the fan section 22 and first compressor section 12. First compressor section 12 pressurizes the air into compressed air, which raises the temperature of the air. Some or all of the pressurized air leaving an outlet of first compressor section 12 enters intercooler 32. Fluid system 34 may be utilized to promote the movement of air to overcome pressure differentials within the cooling circuit 30 and push the air into heat sink 36. A secondary fluid captures some of the heat in the compressed air thereby reducing its temperature. The secondary fluid is then pumped to the fan section, where it is cooled by the fan air and then returned back to the intercooler 32. A portion of the air entering fan section 22 is directed into cooling circuit 30, while the rest is moved to exhaust through nozzle section 24. The air flows from the fan through the cooling circuit 30 into heat sink 36, and cools the air from first compressor section 12. The cooled pressurized air is then returned to intercooler 32 and flows to an inlet for second compressor section 14. Simultaneously, the secondary fluid in heat sink 36 that absorbs the heat is exhausted through nozzle section 24.

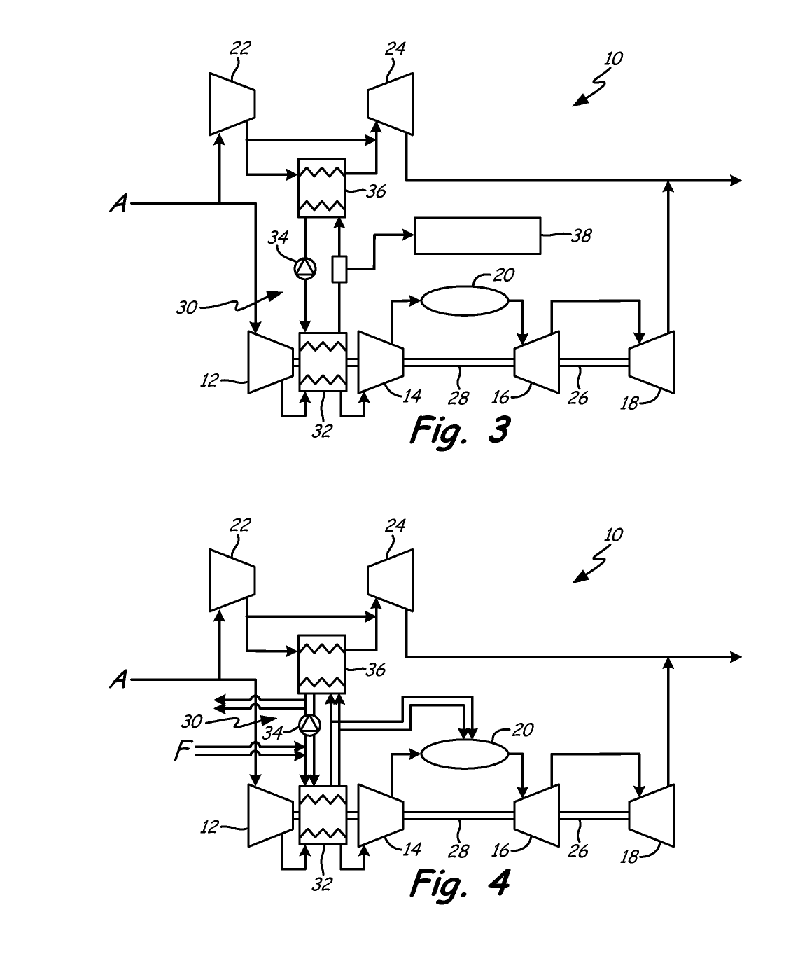

In FIGS. 2-7, turbine engine 10 is similar to that illustrated in FIG. 1, and like numerals indicate like components. Turbine engine 10 may include a first compressor section 12, a second compressor section 14, a first turbine section 16, a second turbine section 18, a combustor section 20, a fan section 22, and nozzle section 24. First shaft 26 connects first compressor section 12 to second compressor section 18, and second shaft 28 connects second compressor section 14 to first turbine section 16. Turbine engine 10 may also include cooling circuit 30 having intercooler 32. Airflow A through the engine is noted by arrows. Some components may not be illustrated in each FIG., and additional components not in FIG. 1 will be listed and described with respect to each FIG.

FIG. 2 is a schematic view of turbine engine 10 with direct intercooling. As illustrated in FIG. 2, intercooler 32 is directly connected to the fluid sources providing heat transfer. Similar to the embodiment illustrated in FIG. 1, air enters turbine engine 10, and a portion may be provided to each fan section 22 and first compressor section 12. Some or all of the pressurized air leaving an outlet of first compressor section 12 enters intercooler 32, which may be a heat exchanger located within the core of the engine. A portion of the air entering fan section 22 is directed into cooling circuit 30, while the rest is moved to exhaust through nozzle section 24. The portion of air from the fan flows through intercooler 32, and cools the air from first compressor section 12. The cooled pressurized air flows to an inlet for second compressor section 14.

FIG. 3 illustrates that the cooling circuit utilizes a working fluid as the heat sink 36. Air is compressed by first compressor section 12, and then the compressed air is passed through cooling circuit 30 that includes intercooler 32. The working fluid is introduced to power generation circuit 38, which is a sub-circuit of cooling circuit 36. A secondary fluid such as supercritical CO2 or steam is utilized as the working fluid in the power generation circuit 38. Other known components may also be utilized in power generation circuit 38, including conduits, valves, compressors, condensers, turbines, reservoirs, and similar structures known to those of skill in the art. The working fluid allows for work recovery by an auxiliary system, such as a gear box or turbine for a power generator. The air entering fan section 22 will act as the heat sink for the power generation fluid. Air flow through fan 22 is used as cooling fluid that draws heat from the compressed air. The cooled air in intercooler 32 is fed into the second compressor section 14. Fluid system 34, as previously described, may be utilized to promote the movement of the work fluid to overcome pressure differentials within the cooling circuit 30, and to direct the cooled air into second compressor 14. Simultaneously, the air passing through heat sink 36 that absorbs the heat is exhausted through nozzle 24.

FIG. 4 is an embodiment of cooling circuit 30 that utilizes fuel in heat sink 36. In this embodiment, air enters turbine engine 10, and a portion may be provided to each the fan section 22 and first compressor section 12. Some or all of the pressurized air leaving an outlet of first compressor section 12 enters intercooler 32. A portion of the air entering fan section 22 is directed into the heat exchanger to be a secondary fluid of heat sink 36, while the rest is moved to exhaust through nozzle section 24. Fuel F from the aircraft fuel system is fed into cooling circuit 30. Fuel F absorbs heat from the compressed air, and the heated fuel is delivered to the fuel delivery system to be added to the combustion mixture. Excess fuel is fed into heat exchanger 36 where it is cooled by part of the fan air and then returns to intercooler 32, which is located in the core of the engine. The secondary fluid (i.e., fan air) in heat sink 36 that absorbs the heat is exhausted through nozzle section 24. The cooled air from intercooler 32 flows to an inlet for second compressor section 14.

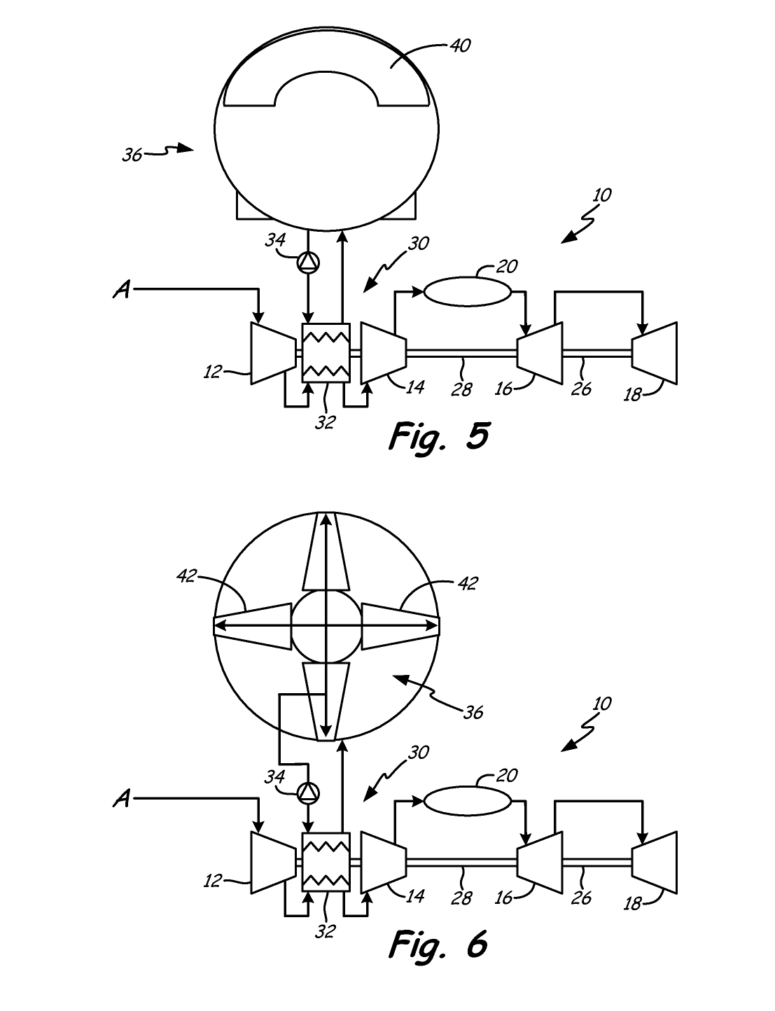

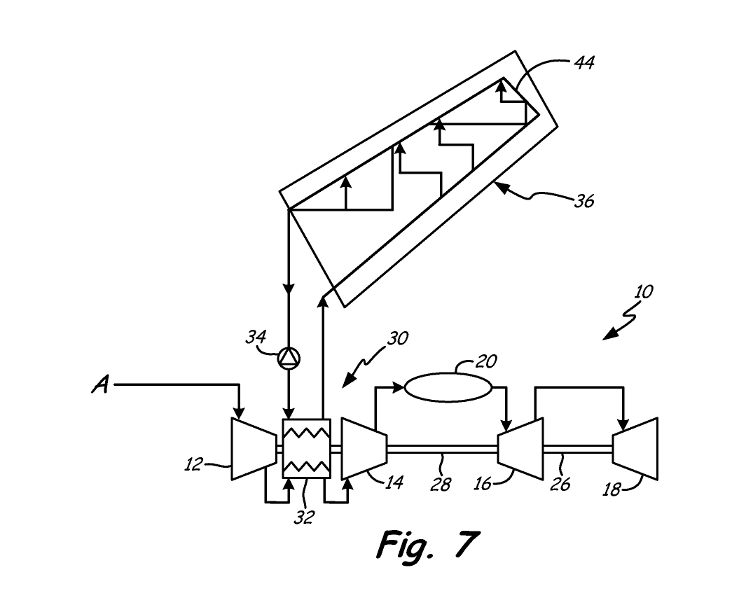

FIGS. 5 and 6 illustrate two embodiments of cooling circuits 30 with indirect intercooling systems incorporating fan section 22. In FIG. 5, intercooler 32 receives compressed air from the outlet of first compressor 12. The fan air is fed to heat sink 36 contained in the fan duct of fan section 22. Heat sink 36 may be surface heat exchanger 40 in the fan duct. A secondary fluid is passed between the heat sink 36 and intercooler 32. The cooled secondary fluid is then returned to intercooler 32 to absorb heat from the compressed air, which is then fed to an inlet for second compressor section 14. Fluid system 34, as previously described, may be utilized as a secondary fluid system that exchanges heat between the secondary fluid and the fan air by means of heat exchangers, such as intercooler 32 and heat sink 36, and to promote the movement of secondary within the cooling circuit 30. The cooled compressed air flows into second compressor 14. Simultaneously, the fan air in heat sink 36 that absorbs the heat is exhausted.

FIG. 6 illustrates that the cooling circuit utilizes fan struts 42 as the head sink 36. The air entering fan section 22 will pass adjacent fan struts 42 containing a secondary fluid that contacts compressed air from first compressor 12 in intercooler 32. The secondary fluid cools the compressed air in intercooler 32, and then the compressed air flows to an inlet for second compressor section 14. Fluid system 34, as previously described, may be utilized as a secondary fluid system that exchanges heat between the compressor air and the fan air by means of heat exchangers, such as intercooler 32 and heat sink 36. The cooled compressed air flows into second compressor 14. Simultaneously, the air in heat sink 36 that absorbs the heat from the secondary fluid is exhausted.

FIG. 7 illustrates another embodiment of cooling circuits 30 with an indirect intercooling system. In FIG. 7, intercooler 32 receives pressurized air from the outlet of first compressor 12. The pressurized air is fed to heat sink 36, which may be a surface heat exchanger in wing 44 of an aircraft. Air flow over wing 44 is used a cooling fluid that draws heat from a secondary fluid in cooling circuit 30. Additionally, the secondary fluid, which has an elevated temperature, may be utilized as a part of an anti-icing system on the aircraft wing. The cooled pressurized air is then passed to an inlet for second compressor section 14. Fluid system 34, as previously described, may be utilized as a secondary fluid system that exchanges heat between the compressor air and the fan air by means of heat exchangers such as intercooler 32, which is located in the engine core, and surface heat exchanger in wing 44.

The disclosed embodiments allow for intercooling the core airflow of an aircraft turbine engine 10 between different compression stages. Aerospace application of intercooling with a gas turbine engine provides opportunities for additional benefits to auxiliary components and/or systems without the drawbacks of the known systems. Typically, this cooling will be effected between pressure ratios 1.5 and 5 for most effectiveness. Overall, engines often have pressure ratios of between 40 and 50 for the entire compressor section, including both the first and second compressor sections 12 and 14. With intercooling, the pressure ratio may be raised much higher, even up to 70, using same compressor material. Providing an intercooler 32 cools the fluid prior to additional compression of the fluid. Intercooling reduces the work required for compression in the successive stages contained in second compressor section 14, thus increasing engine efficiency. The intercooler may be placed between a low pressure stage and a high pressure stage, or between stages of only either the low pressure stage or high pressure stage.

Compressor air may also be bled from the system and forwarded for cooling in first and second turbine sections 16 and 18. Intercooled air also delivers cooler air for turbine cooling, thus reducing consumption of turbine cooling air, which also adds to overall engine efficiency. Moreover, the cooled air going into second compressor section 14 helps increase the corrected speed, so that shafts 26 and 28 may be run at a lower mechanical speed, making the engine lighter and reducing bearing loads.

As illustrated in the aforementioned embodiments, the cooling is accomplished in one of many ways. These alternatives can be categorized based on cooling media used as well as the location of the heat exchangers and heat sinks. The heat exchanger can be located coaxially in the core between low and high stages of compressor as shown in FIG. 1, or it can be located in the fan duct (FIGS. 5 and 6) where air is taken out of the compressor, cooled and returned to compressor. The heat exchanger may be plate-fin or microchannel type for high heat transfer to weight ratio, and operate in coflow, counterflow or cross-flow configuration (or any combination thereof). The heat exchanger may be a surface heat exchanger (FIG. 5), or can be of any structures known to those of skill in the art, such as a heat-pipe type as well. The heat exchanger material may be metal, ceramic, graphite, or high temperature plastic. The ultimate heat sink may be fan air, or fuel that is burnt in the engine combustor. Further examples of a heat sink are any acceptable secondary fluid, including engine oil, fuel, PAO, supercritical CO2, Helium, water (or water/glycol mixtures), or combinations thereof in the heat exchanger structure. In an alternative embodiment, work or heat can be extracted from the secondary fluid to serve some useful function on board the aircraft, such as providing power to run a generator via a gear box, or providing heat to the cockpit or cabin. The heat can also be dissipated by using the large surface area available on the wings while serving as an anti-icing device (FIG. 7). If fan air is used as the ultimate heat sink, then the heat added to the fan air increases the propulsive power of the fan, and thus help compensate for fan pressure loss.

Utilizing the embodiments disclosed herein, a method of generating power may be utilized. The method includes pressurizing air during a first compression stage, and further pressurizing the air during a second compression stage. Heat is transferred from the pressurized air between the first compression stage and second compression stage by passing the pressurized air adjacent a secondary fluid. A mixture of the further pressurized air and fuel is combusted.

In another embodiment, the method includes extracting work from the secondary fluid. Alternately, the heat transferred from by the secondary fluid may be utilized in an anti-icing device contained on an aircraft. In yet another embodiment, the heat transferred from the secondary fluid may be used to increase propulsive power of a fan of an aircraft engine.

### DISCUSSION OF POSSIBLE EMBODIMENTS

The following are non-exclusive descriptions of possible embodiments of the present invention.

A turbine engine has a fan comprising a duct and supporting struts, a first compressor configured to pressurize inlet air, and a second compressor configured to further pressurize the inlet air. A cooling circuit is located to cool the inlet air after the inlet air is pressurized by the first compressor and before the inlet air is further pressurized by the second compressor, and includes at least one intercooler configured to transfer heat from inlet air to a fluid source or heat sink.

The engine of the preceding paragraph can optionally include, additionally and/or alternatively any, one or more of the following features, configurations and/or additional components:

the fluid source or heat sink may be air passing through the fan comprising a duct and supporting struts;

the intercooler may be connected to a surface heat exchanger contained within the fan duct;

the intercooler may be coupled to a heat exchanger in the fan struts;

the fluid heat sink may be fuel;

the fluid heat sink may be utilized to power an auxiliary power system;

the fluid may be contained within a conduit system that passes through an aircraft wing attached to the turbine engine; and/or

the conduit system acts as an anti-icing device.

In another embodiment, a gas turbine engine has a fan with a duct and supporting struts, a low pressure turbine, a low pressure compressor coupled to the low pressure turbine by a first shaft, a high pressure compressor, a high pressure turbine coupled to the high pressure compressor by a second shaft, a combustor located at an outlet of the high pressure compressor; and an intercooler coupled to an outlet of the low pressure compressor and to an inlet of the high pressure compressor.

The engine of the preceding paragraph can optionally include, additionally and/or alternatively any, one or more of the following features, configurations and/or additional components:

the intercooler may be coupled to the fan comprising a duct and supporting struts;

the intercooler by comprise a surface heat exchanger contained within the fan duct;

the intercooler may be coupled to a heat sink contained within the fan struts;

the intercooler may be connected to a fuel system;

the intercooler may be coupled to a secondary fluid source that is utilized to power an auxiliary power system;

the intercooler is coupled to a secondary fluid that may be contained within a conduit system that passes through an aircraft wing attached to the turbine engine; and/or

the conduit system may be positioned to act as an anti-icing device.

A method of generating power includes pressurizing air during a first compression stage, and further pressurizing the air during a second compression stage. Heat is transferred from the pressurized air between the first compression stage and second compression stage by passing the pressurized air adjacent a secondary fluid, which reduces the temperature of the air. A mixture of the further pressurized air and fuel is combusted.

The method of the preceding paragraph can optionally include, additionally and/or alternatively, any one or more of the following features and/or additional steps:

extracting work from the secondary fluid;

transferring heat from the secondary fluid to an anti-icing device contained on an aircraft; and/or

transferring heat from the secondary fluid to increase propulsive power of a fan of an aircraft engine.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A turbine engine comprising:
a fan;
a first compressor stage configured to pressurize inlet air;
a second compressor stage configured to further pressurize the inlet air; and
a cooling circuit located to cool the inlet air after the inlet air is pressurized by the first compressor stage and before the inlet air is further pressurized by the second compressor stage, the cooling circuit including:
at least one intercooler configured to transfer heat from inlet air to a fluid heat sink.

2. The turbine engine of claim 1 wherein the fluid heat sink is air from the fan comprising a duct and supporting struts.

3. The turbine engine of claim 2 wherein the intercooler is coupled to a surface heat exchanger contained within the fan duct.

4. The turbine engine of claim 2 wherein the intercooler is coupled to a heat exchanger in the fan struts.

5. The turbine engine of claim 1 wherein the fluid heat sink is fuel.

6. The turbine engine of claim 1 wherein the fluid heat sink is utilized to power an auxiliary power system.

7. The turbine engine of claim 1 wherein the fluid heat sink comprises a secondary fluid contained within a conduit system that passes through an aircraft wing attached to the turbine engine.

8. The turbine engine of claim 7 wherein the conduit system acts as an anti-icing device.

9. A gas turbine engine comprising:
a fan;
a low pressure turbine;
a low pressure compressor coupled to the low pressure turbine by a first shaft;
a high pressure compressor;
a high pressure turbine coupled to the high pressure compressor by a second shaft;
a combustor located at an outlet of the high pressure compressor; and
an intercooler coupled to an outlet of the low pressure compressor and to an inlet of the high pressure compressor.

10. The gas turbine engine of claim 9 wherein the intercooler is coupled to the fan comprising a duct and supporting struts.

11. The gas turbine engine of claim 10 wherein the intercooler is in fluid communication with a surface heat exchanger contained within the fan duct.

12. The gas turbine engine of claim 11 wherein the intercooler is in fluid communication with a heat sink contained within the fan struts.

13. The gas turbine engine of claim 9 wherein the intercooler is connected to a fuel system.

14. The gas turbine engine of claim 9 wherein the intercooler is coupled to a secondary fluid source that is utilized to power an auxiliary power system.

15. The gas turbine engine of claim 9 wherein the intercooler is coupled to a secondary fluid that is contained within a conduit system that passes through an aircraft wing attached to the turbine engine.

16. The gas turbine engine of claim 7 wherein the conduit system is positioned to act as an anti-icing device.

17. A method of generating power, the method comprising:
pressurizing air during a first compression stage;
further pressurizing the air during a second compression stage;
transferring heat from the pressurized air between the first compression stage and second compression stage by passing the pressurized air adjacent a secondary fluid, wherein the transferring of heat reduces the temperature of the pressurized air; and
combusting a mixture of the further pressurized air and fuel.

18. The method of claim 17 further comprising:
extracting work from the secondary fluid.

19. The method of claim 17 further comprising:
transferring heat from the secondary fluid to an anti-icing device contained on an aircraft.

20. The method of claim 17 further comprising:
transferring heat from the secondary fluid to increase propulsive power of a fan of an aircraft engine.
